(19) United States
(12) Patent Application Publication
(10) Pub. No.: US 2025/0269411 A1
(43) Pub. Date: Aug. 28, 2025

(54) BOTTLE-CLEANING UTENSIL AND METHOD OF USE

(71) Applicant: Riley Spear, Saratoga Springs, UT (US)

(72) Inventors: Riley Spear, Saratoga Springs, UT (US); Joshua Stewart, Florence, KY (US)

(73) Assignee: Riley Spear, Saratoga Springs, UT (US)

(21) Appl. No.: 19/207,340

(22) Filed: May 13, 2025

Related U.S. Application Data
(63) Continuation-in-part of application No. 17/013,818, filed on Sep. 7, 2020, now Pat. No. 12,295,487.
(60) Provisional application No. 62/897,008, filed on Sep. 6, 2019.

(51) Int. Cl. B08B 9/087; A46B 3/02; A46B 9/02; A46D 3/00; B05D 1/06; G09F 23/00

(52) U.S. Cl. CPC B08B 9/087; A46B 3/02; A46B 9/025; A46B 9/026; A46B 2200/3006; A46D 3/00; B05D 1/06; G09F 23/0081

(57) ABSTRACT

A cleaning utensil is disclosed; the utensil may have a coated core and bristle holders for holding bristle assemblies; the cleaning utensil may be in the shape of a trigonal pyramid.

### CROSS-REFERENCE TO RELATED APPLICATIONS

This application is a continuation of U.S. non-provisional patent application Ser. No. 17/013,818, which was filed on Sep. 9, 2020, which claimed the benefit of the following Provisional Patent Applications: 1) U.S. Provisional Patent Application No. 62/897,008, which was filed on Sep. 5, 2019. The benefit of priority to the filing dates of these applications is hereby claimed. The subject matter of all of these applications is expressly incorporated herein by reference in their entirety for all purposes.

### TECHNICAL FIELD

The disclosure relates generally to an apparatus for cleaning a container, such as a bottle or jar. Specifically, the disclosure relates to a cleaning utensil removing bacteria or bacterial biofilms from a container.

### BACKGROUND

Water bottles, baby bottles, kitchen containers, and camping gear are known for being difficult to clean. Hand-held bottle washing implements, e.g., brushes, used for washing bottles and similar kitchen objects are generally known.

These implements, however, are subject to limitations. When being used, the shape of a typical brushes may not sufficiently contact corners or other areas of a bottle. Another challenge is generating sufficient pressure to remove bacteria biofilm from the inside of a bottle, even with the use of a typical brush. Additionally, the shape of a bottle and its neck may limit the angles at which a user may orient a typical handle of a brush while scrubbing. The aforementioned limitations may contribute to a need for increased time spent with the brush on the bottle, which may then deter users from frequently or diligently cleaning bottles using the aforementioned brushes. And then a user may find it difficult to clean the bristles of a brush or carry the brush when traveling if bag space is limited.

### BRIEF SUMMARY

A cleaning utensil for cleaning the interior surface of a container is disclosed. The cleaning utensil may be called a scrubber ball and may have a central base which may be surrounded by a plurality of bristles or brushes. Various patterns may be used for the bristles; the drawings only show one embodiment. The pattern of the bristles may be a plurality of parallel lines or may be a single zig-zag line. The pattern of the bristles may also have a plurality of lines that are crossed, similar to an “X”.

### DETAILED DESCRIPTION

A detailed description of the claimed invention is provided below by example, with reference to examples in the appended figures. Those of skill in the art will recognize that the components and steps of the invention as described by example in the figures below could be arranged and designed in a wide variety of different configurations, without departing from the substance of the claimed invention. Thus, the detailed description of the examples in the figures is merely representative of an example of the invention, and is not intended to limit the scope of the invention as claimed.

The central base may also be termed a core. In the preferred embodiments, the central base has at least four bristle holders.

In some instances, numerical values are used to describe features such as spreading factors, output power, bandwidths, link budgets, data rates, and distances. Though precise numbers are used, one of skill in the art recognizes that small variations in the precisely stated values do not substantially alter the function of the feature being described. In some cases, a variation of up to 50% of the stated value does not alter the function of the feature. Thus, unless otherwise stated, precisely stated values should be read as the stated number, plus or minus a standard variation common and acceptable in the art.

In the preferred embodiments, the central base may have a diameter falling in the range of 3 mm to 10 cm. The central base may have one or more materials, such as a silicone cover covering a metallic sphere.

For purposes of this application, a bristle is defined as a stiff filament.

For purposes of this application, a bristle assembly is defined as at least one bristle.

For purposes of this application, a bristle holder is a housing configured to receive at least one bristle assembly; for purposes of this application, a housing is defined as the portion of a structural member, such as a central base, that defines a void shaped to receive at least one bristle assembly.

In the preferred embodiments, the central base is spherical and also made of metallic materials. The central base may be other shapes, such as a square pyramid, pyramid, trigonal pyramid, cube, cuboid, torus, octahedron, hexagonal pyramid, icosahedron, pentagrammic prism, pentagonal prism, triangular prism, cube, cylinder, dodecahedron, hexagonal prism, tetrahedron, cone, or similarly-shaped shapes. The central base may be dense or it may have bristle holes. The bristles which extend from the central base may be natural, synthetic, or a hybrid of natural and synthetic bristles. The weight of the central base may help provide sufficient inertia so as to achieve an optimal scrub pressure. In the preferred embodiments, the central base exceeds a minimum weight threshold but is also below a maximum weight threshold so as to allow for sufficiently rapid acceleration of the central base when the cleaning utensil has been shaken indirectly by a user who has shaken a bottle in which the cleaning utensil is disposed. In the preferred embodiments, the minimum weight of the central base is between 5 grams and 3 lbs. In some preferred embodiments, the weight of the central base is 10 grams.

In the preferred embodiments, the central base may be a dense sphere which may retain the bristles in a pyramidal formation. In the preferred embodiments, the bristles are arranged in a pyramidal layout such that a plurality of bristles are aligned or define between 1 and 20 geometric planes. In the preferred embodiments, the number of geometric planes that are defined by a plurality of bristles is between 3 and 8 geometric planes. In the preferred embodiments, the number of geometric planes that are defined by a plurality of bristles is four.

Bristles patterns may include random dispersion, spiral, cuboidal, coiled, trigonal pyramidal.

The cleaning utensil may be disposed within a container, such as a bottle. The container may have liquid before the cleaning utensil is added, or the liquid may be added simultaneously to when the utensil is added, or the liquid may be added after the cleaning utensil has been added. A method of use may include rotating the container, with the lid on, in a circular motion to generate centrifugal force, side to side, or up and down, or combinations thereon. Detergent may or may not be added to the liquid. In the preferred embodiments, rotating the container in a circular motion may also cause the utensil to rotate in a circular, substantially circular, or generally circular motion, and the centrifugal force that is generated may cause the utensil to keep at least one plane, which may include three rows of bristles, in full contact or substantially full contact with at least one inner face of the container. The inner face of the container may resist the motion of the cleaning utensil. Given that the cleaning utensil has a mass, then the mass of the device and the g-forces of the centrifugal acceleration experienced by the cleaning utensil when it is being rotated may combine to provide scrubbing pressure that is perpendicular, generally perpendicular, or substantially perpendicular to the face of the container. In the preferred embodiments, the cleaning utensil may have a triangular shape, generally triangular shape, or substantially triangular shape, such that some or all of the bristles may be angled or extend such that they may be inserted or easily inserted into one or more corners of the container, and in the preferred embodiments the scrubbing force is not substantially decreased since only a portion of the bristles may be inserted into a corner at any moment in time and for any bristle that may be inserted into a corner, only a portion of that bristly may be inserted into the corner. the bristles may be sufficiently long such that only an end portion of the bristle may be inserted into the corner. One skilled in the art would testify that a traditional brush that is used for scrubbing the inner surface of a bottle applies scrubbing force in a direction that is parallel, generally parallel, or substantially parallel to the inner surface that is being scrubbed.

The central base may be cast or machined from a dense non-toxic material such as an alloy; the alloy may include a number of materials, such as 100% iron or a combination of two or more materials. In the preferred embodiments, at least one of the materials that make up the central base is metallic. In the preferred embodiments, there are two metals in the alloy for the central base, which may be bismuth and tin. In the preferred embodiments, the content of the alloy is between 40% and 65 bismuth and the remaining material in the alloy may be tin. The percentage of the tin may be 100% minus the percentage of the bismuth. In some preferred embodiments, the alloy is 58% bismuth and 42% tin.

Holes configured for bristles or apertures configured for bristles may be disposed upon the surface of the central base; these holes or apertures may be referred to a bristles hole or bristle holes. A bristle holder is defined as the 3-dimensional area of the central base which defines a hole; the bristle holder includes the bottom surface of the central base that is located at the bottom of the hole. The holes or apertures may be disposed in such a way that a trigonal or triangular pyramid may be formed by the bristles that have been disposed in the bristle holes. In the preferred embodiments, the surface of the central base is generally or substantially smooth; in the preferred embodiments, the surface of the central base is substantially free of defects so as to decrease the likelihood that dirt, soil, bacteria, or other unclean things may be caught inside of the defects.

The minimum length of the bristle that is disposed within a bristle hole is 0.03 mm.

The maximum length of the bristle that is disposed within a bristle hole is 90 cm.

In the preferred embodiments, the length of the bristle that is disposed within a bristle hole ranges between 0.03 mm and 90 cm.

At least 10 percent of the length of the bristles may be disposed within the hole.

In the preferred embodiments, no more than 45% of the bristle is disposed with in the hole.

In the preferred embodiments, the ideal ranges for the length of the bristles is between 5 mm to 15 mm.

One or more of the bristle holes, ideally all of the bristle holes, may receive a number of bristles. The method for forming the central base may be to insert, stuff, or dispose one more bristles into the hole configured for the bristles. The bristles may then be secured in place. Some ways for securing are using an adhesive, such as after drilling a hole and adding an amount of adhesive and then adding the one or more bristles. Bristles may be trimmed so as to form a sharp, angular 4-sided pyramid; a clamp and a leveler may be used during the trimming process. In the preferred embodiments, one or more bristles that are perpendicular to the same cutting plane and a cutting tool, such as a jig, may be positioned at a specific distance from the cutting plane. The bristles may have a coating. Various materials may be used for bristles, including hog hair or synthetic hair.

In the preferred embodiments, the minimum length for a bristle is 0.001 mm and in the preferred embodiments the maximum length is 200 cm. Various bristle stiffness and bristle length may be used. Brushes may have a direct relationship between bristle stiffness and length. In some embodiments, the length of the bristles are between 4 and 7 cm.

The bristles or the surface of the central base may be treated with antimicrobial coatings.

A bristle assembly may have tips of individual bristles that are aligned such as to form an mathematical line defining the edges of a trigonal pyramidal shape.

In some embodiments, the cleaning utensil may undergo a process to coat the exterior for design purposes. A method of forming the cleaning utensil may include coating the metal of the core, which may be a metal ball. One purpose of the coating may be to provide an area upon which a design may be placed upon the core, which may serve as the central structure of the cleaning utensil. The core, which in the preferred embodiments includes a metallic ball, may be thoroughly cleaned to remove any surface contaminants, oils, or debris that may inhibit the adherence of subsequent coatings (step 120 in FIGS. 12, 13 & 14). Acceptable cleaning agents may include degreasers such as isopropyl alcohol or commercially available cleaning solutions such as a cleaning solution containing methylchloroisothiazolinone.

Following surface cleaning, the metallic core may be subjected to abrasive blasting techniques—such as sandblasting or bead blasting—to remove any existing coatings or corrosion and to roughen the surface, thereby enhancing powder adhesion (step 150 in FIGS. 12, 13 & 14). However, surface cleaning of the metallic core is not a required step.

In some embodiments, a plurality of holes may be pre-drilled or precast into the metallic core at designated positions intended for the later insertion of bristle assemblies (step 130 in FIG. 12, and step 110 in FIG. 14). Each hole may be sized and shaped to accommodate a bristle bundle with or without a ferrule base. Prior to the powder coating step, these holes may be masked with materials such as high-temperature-resistant materials, such as silicone plugs or high-temperature masking tape, to prevent obstruction of the holes during the coating step when a material, such as a powder material, is caused to adhere to the metallic core (step 140 in FIG. 12 and FIG. 13).

The metallic core may be then subjected to a powder coating process. In this step, the core may be electrically grounded and a thermoset powder material may be applied to its surface using an electrostatic spray gun (step 150 in FIGS. 12, 13 & 14). The powder will normally adhere uniformly to the grounded metallic surface. To ensure even coverage, the core may be rotated during spraying, and special care may be taken to avoid excessive buildup of powder around the masked hole regions.

After application, the powder-coated core may be placed in a curing oven where it is heated to a temperature generally ranging from 350° F. to 400° F., as recommended by the powder manufacturer. The heat typically causes the powder particles to melt and chemically cross-link, forming a continuous, durable coating. The core may then be removed from the oven and allowed to cool.

Once the core is fully cured and cooled, the masking materials may be removed, exposing the clean, uncoated holes (step 160 in FIGS. 13 & 14). In some embodiments, all, substantially all, or some of any residual powder that may have entered into the holes of the metallic core may be removed, such as by using a sharp instrument or small file.

A suitable adhesive, such as a two-part epoxy compatible with both metal and nylon, may be then applied into each hole (step 170 in FIGS. 12, 13 & 14). Special the adhesive may be applied to the holes, and in the preferred embodiments, the application of the adhesive to the holes is done in a substantially uniform manner and in quantities sufficiently low so as to reduce or avoid overlowing the holes with the adhesive. Bristle assemblies, which may contain fibers such as nylon fibers, may be then inserted into the adhesive-filled holes. The bristles may be bundled together, such as being bundled via a ferrule or crimped base to facilitate substantially uniform insertion into the holes of the metallic core and bonding of the bristles to the bottom of the holes or to other bristles\(step 180 in FIGS. 12, 13 & 14).

The adhesive may then be allowed to cure for a manufacturer-specified duration, during which the coated core is left undisturbed to allow a substantially strong or substantially permanent bond to form between the bristle assemblies and the metallic core (step 190 in FIGS. 12, 13 & 14). After curing, the bristles may be trimmed to a uniform length or shaped for an intended cleaning application. Excess adhesive on the surface of the core may be cleaned, such as via a solvent or scraping tool.

In certain embodiments, a design, logo or brand marking may be applied to the powder-coated surface using a screen printing process. The surface is first cleaned of dust and oils, and a custom logo is printed using a squeegee and screen printing ink. The logo then may be cured, either by heat or ultraviolet light, in accordance with the ink manufacturer's specifications. The coating may be of a certain color, such as via a dye, so that the appearance of the coated metallic core may appeal to certain types of purchasers. For examples, fans of the Chicago Bulls may be more inclinded to purchase a coated metallic core that has a red coat

The resulting product may be a robust, corrosion-resistant cleaning utensil with integrated bristles and an aesthetically appealing, durable outer finish.

### BRIEF DESCRIPTION OF THE DRAWINGS

A more particular description of the invention briefly described above is made below by reference to specific examples. Several examples are depicted in drawings included with this application. An example is presented to illustrate, but not restrict, the invention. When bristle assembly counts are given in the brief description of the figures, then that represents the total bristle assemblies for the embodiment even if not all shown in that view (unless otherwise noted).

FIG. 1 illustrates a perspective view of an embodiment of a cleaning utensil;

FIG. 2A illustrates a top view of a cleaning utensil;

FIG. 2B illustrates a perspective, left side view of an embodiment of a cleaning utensil;

FIG. 2C illustrates a perspective, right side view of an embodiment of a cleaning utensil; and,

FIG. 2D illustrates a front view of an embodiment of a cleaning utensil;

FIG. 3A illustrates a side view of an embodiment of a cleaning utensil comprising the central base with 14 bristle assemblies (11 bristle assemblies are shown);

FIG. 3B illustrates a top view the embodiment of the cleaning utensil depicted in FIG. 3A;

FIG. 3C illustrates a perspective view of the embodiment of the cleaning utensil depicted in FIG. 3A, in which the left bristle assembly has been rotated along the equator towards the right bristle assembly and also has been rotated downwards;

FIG. 4A illustrates a front view of an embodiment of a cleaning utensil comprising a central base with 4 bristle assemblies;

FIG. 4B illustrates a back view of the embodiment shown in FIG. 4a;

FIG. 4C illustrates a perspective view of the embodiment of the cleaning utensil depicted in FIG. 4A, in which the left bristle assembly has been rotated along the equator towards the right bristle assembly and also has been rotated downwards;

FIG. 5A illustrates a top view of an embodiment of a cleaning utensil comprising the central base with 6 bristle assemblies;

FIG. 5B illustrates a bottom view of an embodiment shown in FIG. 5a of a cleaning utensil;

FIG. 5C illustrates a perspective view of the embodiment of the cleaning utensil depicted in FIG. 5A, in which the left bristle assembly has been rotated along the equator towards the right bristle assembly and also has been rotated downwards;

FIG. 6A illustrates a top view of an embodiment of a cleaning utensil comprising the central base with 7 bristle assemblies;

FIG. 6B illustrates a bottom view of the embodiment shown in FIG. 6A;

FIG. 6C illustrates a perspective view of the embodiment of the cleaning utensil depicted in FIG. 6A, in which the left bristle assembly has been rotated along the equator towards the right bristle assembly and also has been rotated downwards;

FIG. 7A illustrates a top view of an embodiment of a cleaning utensil comprising the central base with 26 bristle assemblies;

FIG. 7B illustrates a bottom view of the embodiment of the cleaning utensil shown in FIG. 7A;

FIG. 7C illustrates a perspective view of the embodiment of the cleaning utensil depicted in FIG. 7A, in which the left bristle assembly has been rotated along the equator towards the right bristle assembly and also has been rotated downwards;

FIG. 8A illustrates a top view of the embodiment of a cleaning utensil comprising the central base and 54 bristle assemblies;

FIG. 8B illustrates a bottom view of the embodiment of the cleaning utensil shown in FIG. 8A;

FIG. 8C illustrates a perspective view of the embodiment of the cleaning utensil depicted in FIG. 8A, in which the left bristle assembly has been rotated along the equator towards the right bristle assembly and also has been rotated downwards;

FIG. 9A illustrates a top view of an embodiment of a cleaning utensil comprising the central base with 40 bristle assemblies;

FIG. 9B illustrates a bottom view of the embodiment of the cleaning utensil shown in FIG. 9A.

FIG. 9C illustrates a perspective view of the embodiment of the cleaning utensil depicted in FIG. 9A, in which the left bristle assembly has been rotated along the equator towards the right bristle assembly and also has been rotated downwards;

FIG. 10A illustrates a three dimensional view of the cleaning utensil with drilled holes for bristles. Perspective is shown from the front.

FIG. 10B illustrates a three dimensional view of the cleaning utensil with drilled holes for bristles. Perspective is shown from the right.

FIG. 10C illustrates a three dimensional view of the cleaning utensil with drilled holes for bristles. Perspective is shown from the bottom.

FIG. 10D illustrates a three dimensional view of the cleaning utensil with drilled holes for bristles. Perspective is shown from the left.

FIG. 11A illustrates the spot of where a logo would be place on the core of the cleaning utensil.

FIG. 11B illustrates a Nike® logo on the core of the cleaning utensil

FIG. 11C illustrates a pattern logo on the core of the cleaning utensil

FIG. 11D illustrates an Eagles® logo on the core of the cleaning utensil

FIG. 12 illustrates a method of making a cleaning utensil with a cured powder coating wherein the holes for bristles are drilled after coating.

FIG. 13 illustrates a method of making a cleaning utensil with a cured powder coating wherein the holes for bristles are drilled before coating.

FIG. 14 illustrates a method of making a cleaning utensil with a cured powder coating wherein the core has precast holes.

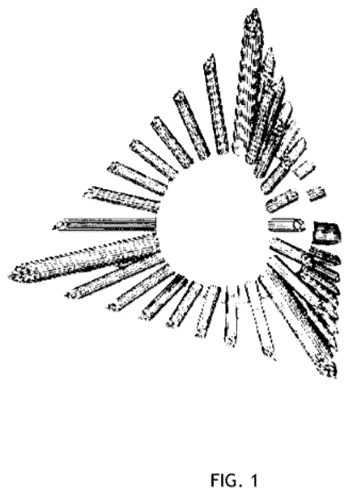

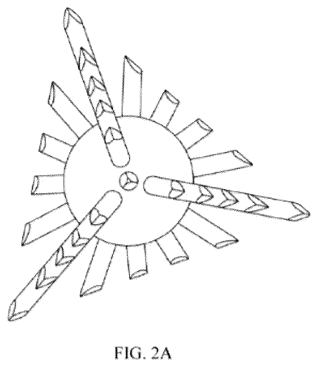

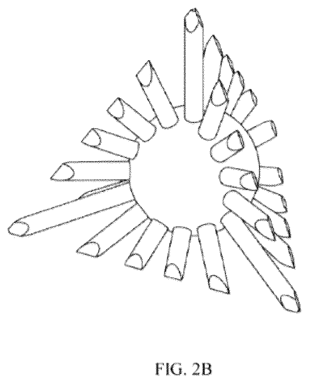

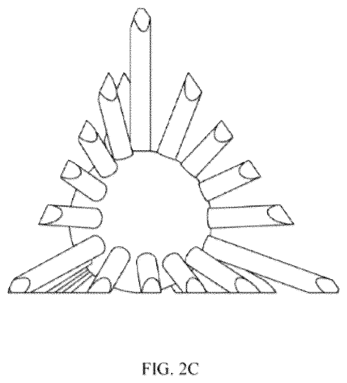

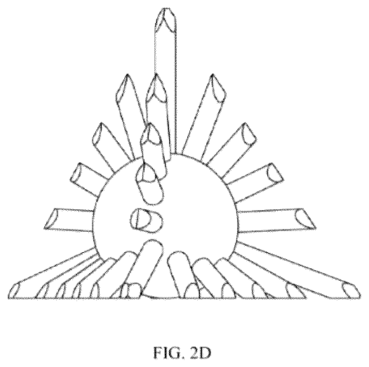

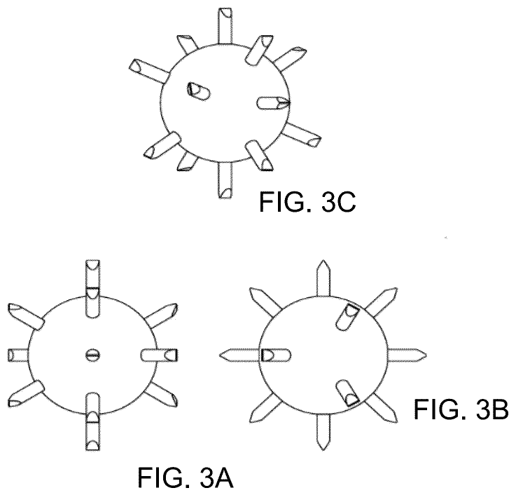

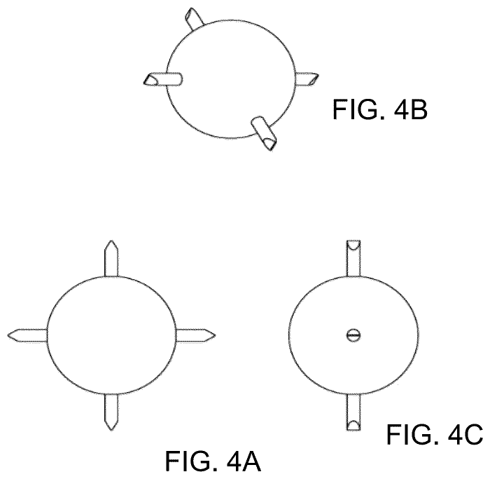

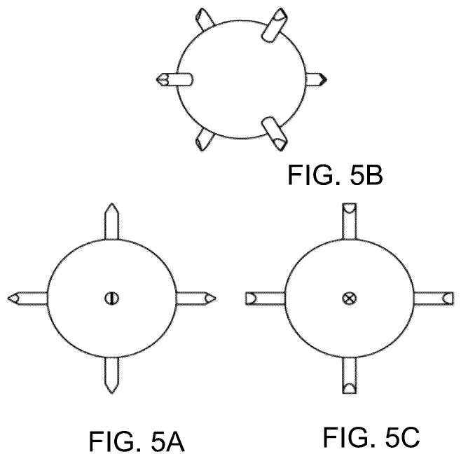

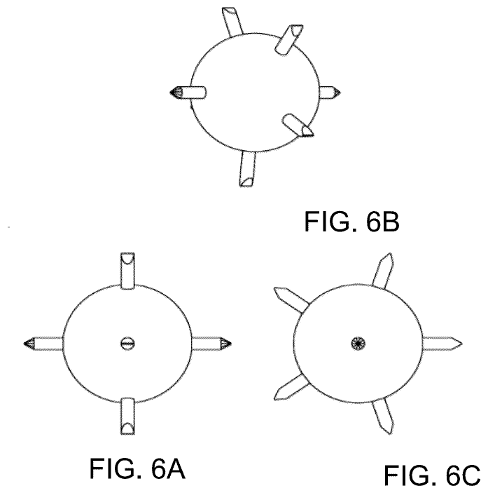

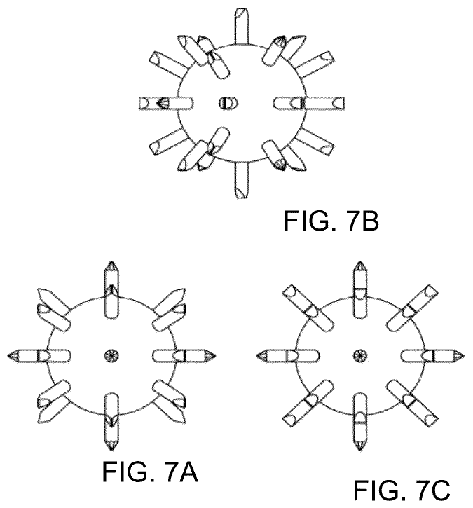

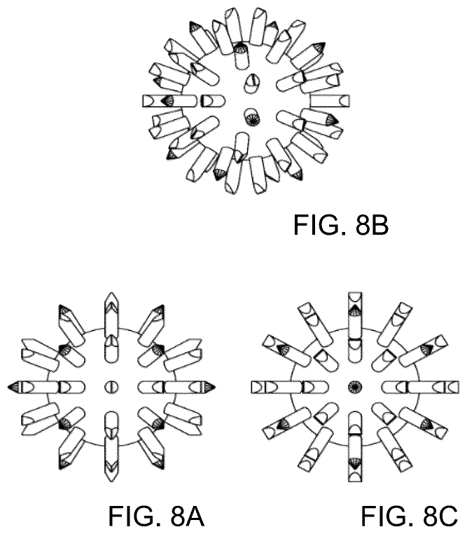

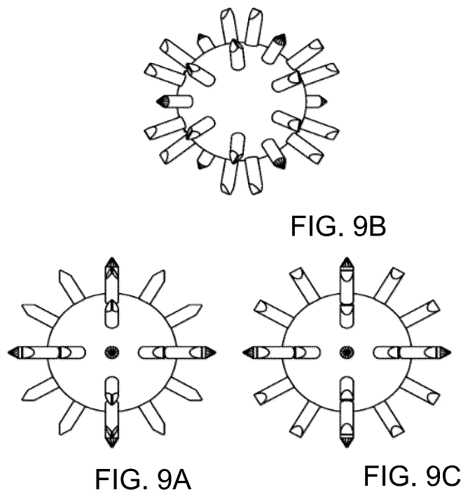

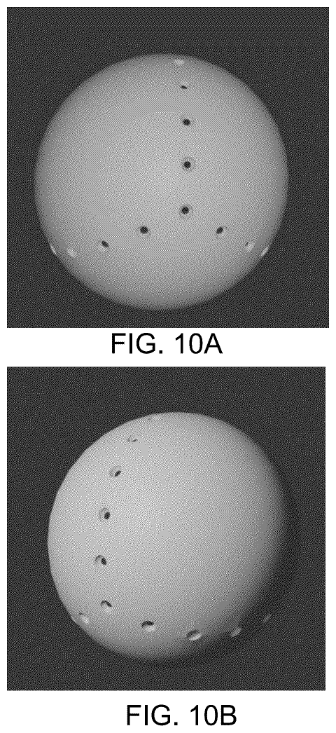

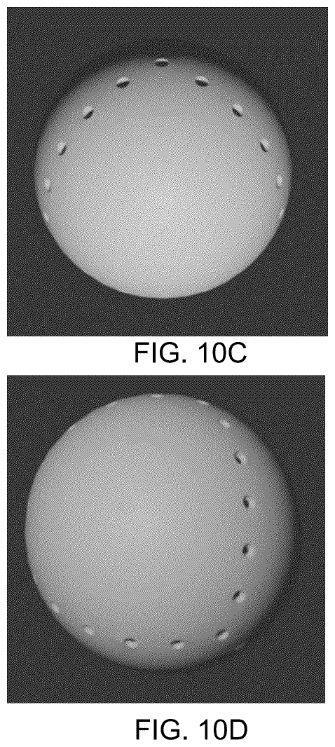

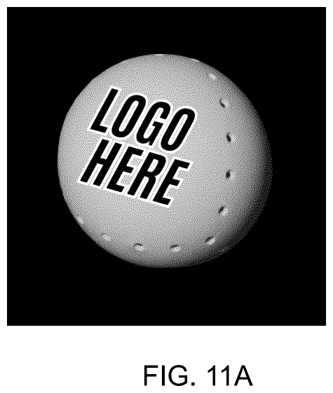

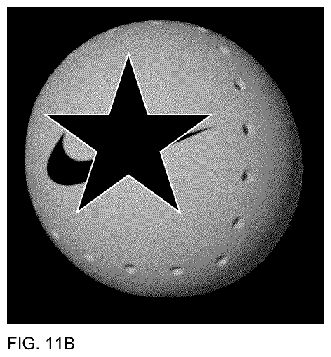

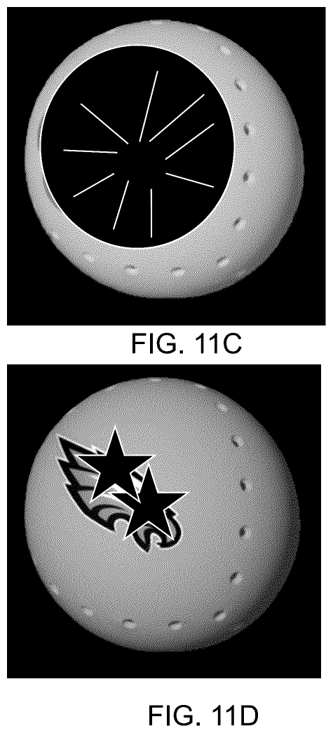

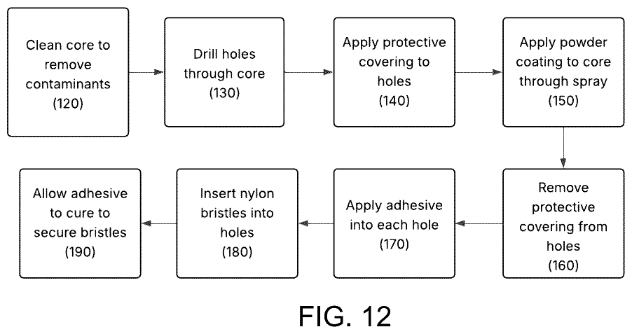

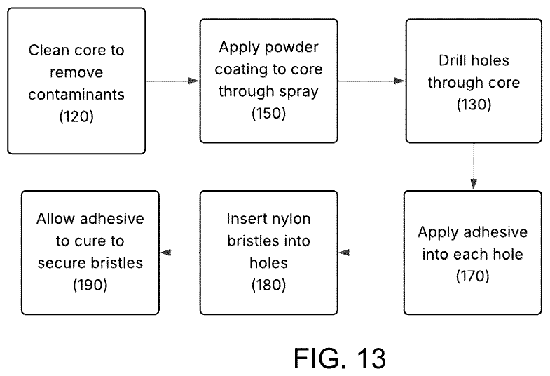

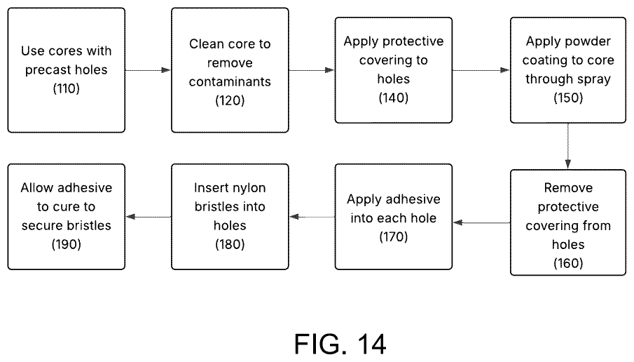

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

1. A cleaning utensil comprising a coated central base, the coated central base having at least four bristle holders, wherein at least one bristle assembly is coupled to each of the at least four bristle holders, wherein each bristle assembly of the at least one bristle assembly comprises an outer tip, wherein the at least four bristle holders define a substantially trigonal pyramid shape having six edges collectively outlining four faces of the substantially_trigonal pyramid shape, wherein the at least four bristle holders define the six edges, wherein a plurality of central areas of the central base collectively below each of the four faces of the substantially trigonal pyramid shape are free from any bristle holders and bristles.

2. The cleaning utensil of claim 1, wherein the coated central base is a coated metallic sphere.

3. The cleaning utensil of claim 2, wherein the central base is a metallic sphere coated with a cured powder coating.

4. The cleaning utensil of claim 2, wherein the at least four bristle holders define a trigonal pyramid shape.

5. The cleaning utensil of claim 2, wherein each of the at least one bristle assembly coupled to each of the at least four bristle holders are disposed within one of the at least four bristle holders, wherein each outer tip of the at least one bristle assembly of the at least four bristle holders collectively define a substantially trigonal pyramid shape.

6. The cleaning utensil of claim 2 wherein an angle between a first aligned row of bristles in a first bristle assembly line and a second aligned row of bristles is substantially 109.5 degrees.

7. The cleaning utensil of claim 6 wherein the first aligned row of bristles in the first bristle assembly line define an edge of a shape selected from a group consisting of a tetrahedral and a trigonal pyramid shape.

8. The cleaning utensil of claim 1 having a first aligned row of bristles, a second aligned row of bristles, a third aligned row of bristles, and a fourth aligned row of bristles, wherein a point on each of the row of bristles defines a plurality of vertices of a shape selected from a group consisting of a trigonal pyramid shape and a tetrahedral shape.

9. The cleaning utensil of claim 1 having a first aligned row of bristles, a second aligned row of bristles, a third aligned row of bristles, and a fourth aligned row of bristles, wherein a centralized point on each of the row of bristles defines a plurality of vertices of a shape selected from a group consisting of a trigonal pyramid shape and a tetrahedral shape.

10. A method of using a cleaning utensil comprising:
providing a cleaning utensil comprising a coated central base, the coated central base having at least four bristle holders, wherein at least one bristle assembly is coupled to each of the at least four bristle holders, wherein each bristle assembly of the at least one bristle assembly comprises an outer tip, wherein the at least four bristle holders define a substantially trigonal pyramid shape having six edges collectively outlining four faces of the substantially trigonal pyramid shape, wherein the at least four bristle holders define the six edges, wherein a plurality of central areas of the coated central base collectively below each of the four faces of the substantially trigonal pyramid shape are free from any bristle holders and bristles;
disposing the cleaning utensil within a container;
shaking the container; and,
removing the cleaning utensil.

11. The cleaning utensil of claim 1, wherein the coated central base comprises at least twenty four bristle holders, wherein the at least twenty four bristle holders define the substantially trigonal pyramid shape having six edges, wherein the at least twenty four bristle holders define the six edges.

12. The cleaning utensil of claim 2, wherein the at least four bristle holders number no more than 54.

13. The cleaning utensil of claim 2, wherein the at least four bristle holders number less than 40.

14. The cleaning utensil of claim 2, wherein the at least four bristle holders number less than 29.

15. The cleaning utensil of claim 2, wherein the coated central base comprises a silicone coating.

16. The cleaning utensil of claim 1 wherein the coated central base comprises a powder coating that has been cured at a temperature sufficient substantially adhere coating to the central base.

17. A method of making a cleaning utensil with a central core comprising:
cleaning a metallic core to remove contaminants;
applying a powder coating to the entire surface of the metallic core using an electrostatic spray process so as to form a powder-coated metallic core;
curing the powder-coated metallic core in an oven at a predetermined temperature for a predetermined duration;
drilling a plurality of holes through the cured powder coating and into the metallic core at designated locations, wherein the drilling occurs temporally after the step of curing the powder-coated metallic core in an oven, applying adhesive into each of the drilled holes;
inserting nylon bristles into the adhesive-filled holes; and
allowing the adhesive to cure to permanently secure the bristles to the metallic core.

18. The method of claim 17, wherein the plurality of holes are drilled before the powder coating and curing steps, and further comprising applying a protective covering over the drilled holes before coating is applied.

19. The method of claim 17, wherein the balls provided are pre-casted with holes, and the drilling step is removed, and a protective covering applied to the holes before coating.
